(19) United States
(12) Patent Application Publication
(10) Pub. No.: US 2005/0198409 A1
(43) Pub. Date: Sep. 8, 2005

(54) Display device for displaying state information of an electronic apparatus

(75) Inventors: Ping-Hung Chen, Taipei Hsien (TW); Chun-Kai Yang, Taipei Hsien (TW); Chun-Kuan Tsu, Taipei Hsien (TW)

Correspondence Address: LADAS & PARRY, 5670 WILSHIRE BOULEVARD, SUITE 2100, LOS ANGELES, CA, 90036-5679, US

(73) Assignee: Wistron Corporation

(21) Appl. No.: 10/912,420

(22) Filed: Aug. 4, 2004

(30) Foreign Application Priority Data
Mar. 3, 2004 (TW) 093105542

(51) Int. Cl. G06F 13/10

(52) U.S. Cl. 710/19

(57) ABSTRACT

A display device, which is for displaying state information of an electronic apparatus, includes a display module. The electronic apparatus has an output port, and generates the state information when the electronic apparatus executes an application program. The display module includes a display panel, an input port coupled to the output port of the electronic apparatus so as to receive the state information therefrom, and a controller unit coupled to the input port and the display panel so as to control the display panel to generate a visual indication corresponding to the state information received by the input port. The electronic apparatus is configured so as to transmit the state information to the display module via the output port when the electronic apparatus executes the application program.

### CROSS-REFERENCE TO RELATED APPLICATION

This application claims priority of Taiwanese application no. 093105542, filed on Mar. 3, 2004.

### BACKGROUND OF THE INVENTION

1. Field of the Invention

The invention relates to a display device, more particularly to a display device that displays state information of an electronic apparatus.

2. Description of the Related Art

In U.S. Pat. No. 6,523,122, there is disclosed a computer apparatus that generates power state information when the computer apparatus executes a power management application program, such as the advanced configuration and power interface (ACPI).

The computer apparatus includes a housing, a main board mounted in the housing, a controller unit mounted on the main board, and a conventional display device that includes a display panel mounted on the housing and that is coupled to the controller unit. When the power management application program is executed, the power state information of the computer apparatus is displayed on the display panel of the conventional display device. As such, a current state of the computer apparatus can be confirmed easily and conveniently.

The conventional display device is disadvantageous in that it is inoperable for a computer apparatus that includes a main board without the controller unit.

### SUMMARY OF THE INVENTION

Therefore, the object of the present invention is to provide a display device that includes a standalone display module with a built-in controller unit.

According to the present invention, a display device includes a display module and program module. The display device displays state information of an electronic apparatus. The electronic apparatus has an output port, and generates the state information when the electronic apparatus executes an application program. The display module includes a display panel, an input port adapted to be coupled to the output port of the electronic apparatus so as to receive the state information therefrom, and a controller unit coupled to the input port and the display panel. The controller unit is operable so as to control the display panel to generate a visual indication corresponding to the state information received by the input port. The program module is adapted to be executed by the electronic apparatus, and serves to configure the electronic apparatus to transmit the state information to the display module via the output port when the electronic apparatus executes the application program.

### BRIEF DESCRIPTION OF THE DRAWINGS

Other features and advantages of the present invention will become apparent in the following detailed description of the preferred embodiment with reference to the accompanying drawings, of which:

FIG. 1 is a circuit block diagram of the preferred embodiment of a display device for displaying state information of an electronic apparatus according to the present invention;

FIG. 2 is a perspective view of the electronic apparatus of FIG. 1;

FIG. 3 is a front perspective view of the display device of the preferred embodiment; and

FIG. 4 is a rear perspective view of the display device of FIG. 3.

### DETAILED DESCRIPTION OF THE PREFERRED EMBODIMENT

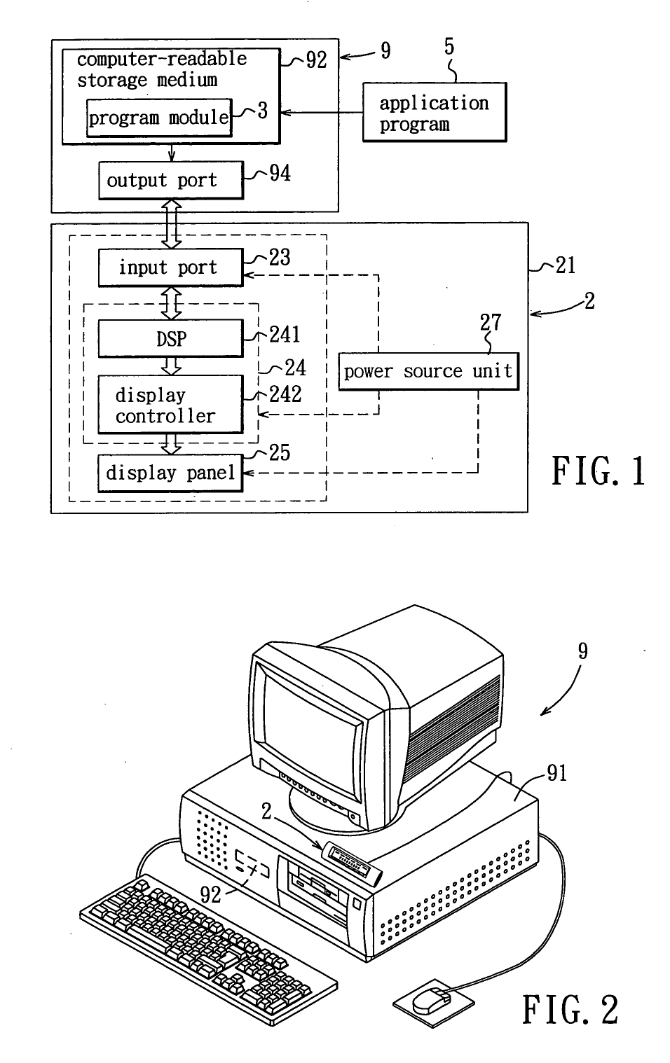

Referring to FIGS. 1 to 4, the preferred embodiment of a display device for displaying state information of an electronic apparatus 9 according to this invention is shown to include a display module 2 and a program module 3.

In this embodiment, the electronic apparatus 9 is a computer apparatus, specifically a desktop personal computer. It is noted that the electronic apparatus 9 may be any other electronic apparatus, such as a digital television set, an audio equipment, etc. As best shown in FIG. 2, the electronic apparatus 9 includes a housing 91, and a computer-readable storage medium 92, specifically a hard disk drive, mounted in the housing 91. It is noted that the computer-readable storage medium 92 may be any other storage medium, such as a read-only memory of the electronic apparatus 9. As best shown in FIG. 1, the electronic apparatus 9 has an output port 93 that is disposed on and that is accessible externally of the housing 91.

The electronic apparatus 9 generates the state information when the electronic apparatus 9 executes an application program 5. In this embodiment, the application program 5 is an MP3 player. However, it is noted that the application program 5 may be any other application program, such as an advanced configuration and power interface (ACPI).

The display module 2 is disposed externally of the electronic apparatus 9. In this embodiment, the display module 2 includes a casing 21, a circuit board 22, a display panel 25, an input port 23, a controller unit 24, and a power source unit 27.

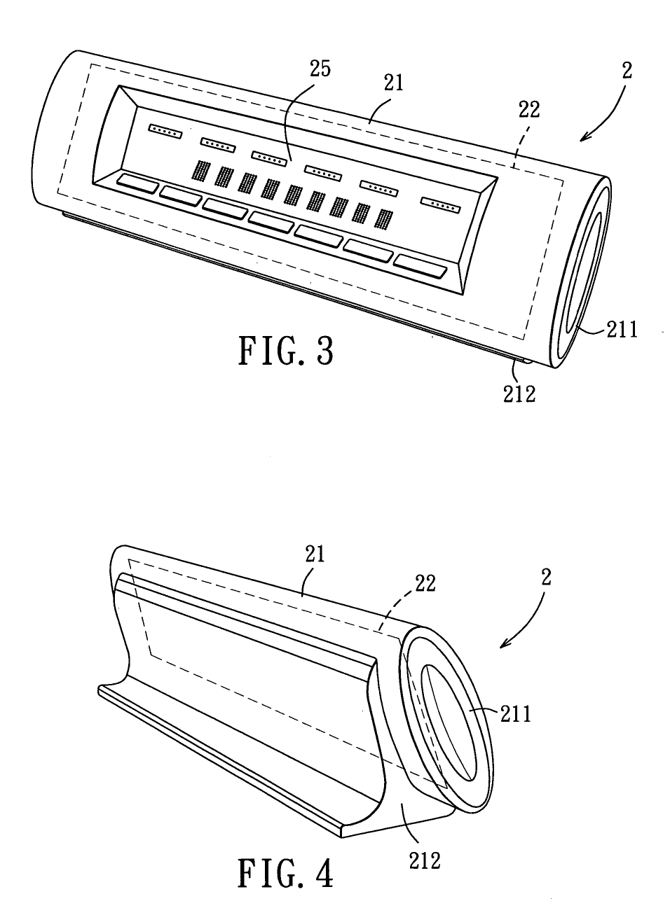

As best shown in FIGS. 3 and 4, the casing 21 includes an accommodating section 211, and a base section 212 that supports the accommodating section 211 for positioning the same on a flat surface (not shown).

The circuit board 22 is mounted in the accommodating section 211 of the casing 21.

The display panel 25 is disposed on the accommodating section 211 of the casing 21, is coupled to the circuit board 22, and is accessible from an outside of the casing 21.

The input port 23 is disposed on the accommodating section 211, is mounted on the circuit board 22, is accessible from the outside of the casing 21, and is adapted to be coupled to the output port 94 of the electronic apparatus 9 so as to receive the state information therefrom. In this embodiment, the input port 23 is adapted to establish a wired communications link with the output port 94 of the electronic apparatus 9. Preferably, the wired communications link is a USB communication link or an IEEE 1394 communications link. In an alternative embodiment, the input port 23 is adapted to establish a wireless communications link with the output port 94 of the electronic apparatus 9. As such, the wired communications link is replaced by a wireless communications link, such as a bluetooth communications link.

The controller unit 24 is disposed in the accommodating section 211 of the casing 21, is mounted on the circuit board 22, and is operable so as to control the display panel 25 to generate a visual indication that corresponds to the state information received by the input port 23. In particular, the controller unit 24 includes a digital signal processor (DSP) 241, and a display controller 242. The DSP 241 is coupled to the input port 23, and processes the state information in accordance with a digital signal processing technique. The display controller 242 is coupled to the DSP 241 and the display panel 25, and converts the processed digital signal into an analog signal, which drives an anode segment (not shown) of the display panel 25.

In this embodiment, the display panel 25 is a vacuum fluorescent display (VFD), and the display controller 242 is a VFD controller. In an alternative embodiment, the display panel 25 is a liquid crystal display (LCD), and the display controller 242 is an LCD controller.

The power source unit 27 is disposed in the accommodating section 211 of the casing 21, is coupled to the circuit board 22, and is operable so as to provide electric power to the input port 23, the controller unit 23, and the display panel 25. In this embodiment, the power source unit 27 includes a plurality of battery cells (not shown). In an alternative embodiment, the power source unit 27 includes a power adapter that is adapted to be coupled to a commercial alternating current power source.

In an alternative embodiment, the housing 91 of the electronic apparatus 9 serves as the casing 21 of the display module 2. As such, the casing 21 of the display module 2 is dispensed with.

The program module 3 is resident in the computer-readable storage medium 92, and is adapted to be executed by the electronic apparatus 9. In this embodiment, the program module 3 serves to configure the electronic apparatus 9 to transmit the state information to the display module 2 via the output port 94 when the electronic apparatus 9 executes the application program 5.

It has thus been shown that the display device of this invention includes a standalone display module 2 with a built-in controller unit 24 and program module 3. As such, when it is desired to display the state information of the electronic apparatus 9 on the display panel 25 of the display module 2, all a user has to do is to connect the display module 2 to the electronic apparatus 9, and operate the electronic apparatus 9 to execute the program module 3 and the application program 5.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A display device for displaying state information of an electronic apparatus that has an output port and that generates the state information when the electronic apparatus executes an application program, said display device comprising:
a display module including
a display panel,
an input port adapted to be coupled to the output port of the electronic apparatus so as to receive the state information therefrom, and
a controller unit coupled to said input port and said display panel, and operable so as to control said display panel to generate a visual indication corresponding to the state information received by said input port; and
program module, adapted to be executed by the electronic apparatus, for configuring the electronic apparatus to transmit the state information to said display module via the output port when the electronic apparatus executes the application program.

2. The display device as claimed in claim 1, wherein said display panel is one of a vacuum fluorescent display and a liquid crystal display.

3. The display device as claimed in claim 1, wherein said input port is adapted to establish a wired communications link with the output port of the electronic apparatus.

4. The display device as claimed in claim 3, wherein the wired communications link is one of a USB communications link and an IEEE 1394 communications link.

5. The display device as claimed in claim 1, wherein said input port is adapted to establish a wireless communications link with the output port of the electronic apparatus.

6. The display device as claimed in claim 5, wherein the wireless communications link is a bluetooth communications link.

7. The display device as claimed in claim 1, wherein said controller unit includes a digital signal processor coupled to said input port, and a display controller coupled to said digital signal processor and said display panel.

8. A display device for displaying state information of an electronic apparatus that has an output port and that is configured to generate the state information and to provide the state information to the output port when the electronic apparatus executes an application program, said display device comprising a display module that includes:
a display panel;
an input port adapted to be coupled to the output port of the electronic apparatus so as to receive the state information therefrom; and
a controller unit coupled to said input port and said display panel, and operable so as to control said display panel to generate a visual indication corresponding to the state information received by said input port.

9. The display device as claimed in claim 8, wherein said display panel is one of a vacuum fluorescent display and a liquid crystal display.

10. The display device as claimed in claim 8, wherein said controller unit includes a digital signal processor coupled to said input port, and a display controller coupled to said digital signal processor and said display panel.

11. An electronic system comprising:
an electronic apparatus having an output port, capable of executing an application program, and capable of generating state information when executing the application program;
a display module including
a display panel,
an input port coupled to said output port of said electronic apparatus so as to receive the state information therefrom, and
a controller unit coupled to said input port and said display panel, and operable so as to control said display panel to generate a visual indication corresponding to the state information received by said input port; and
program module, to be executed by said electronic apparatus, for configuring said electronic apparatus to transmit the state information to said display module via said output port.

12. The electronic system as claimed in claim 11, wherein said display panel is one of a vacuum fluorescent display and a liquid crystal display.

13. The electronic system as claimed in claim 11, wherein said input port establishes a wired communications link with said output port of said electronic apparatus.

14. The electronic system as claimed in claim 13, wherein the wired communications link is one of a USB communications link and an IEEE 1394 communications link.

15. The electronic system as claimed in claim 11, wherein said input port establishes a wireless communications link with said output port of said electronic apparatus.

16. The electronic system as claimed in claim 15, wherein the wireless communications link is a bluetooth communications link.

17. The electronic system as claimed in claim 11, wherein said controller unit includes a digital signal processor coupled to said input port, and a display controller coupled to said digital signal processor and said display panel.

18. The electronic system as claimed in claim 11, wherein said electronic apparatus includes a computer-readable storage medium, said program module being resident in said computer-readable storage medium.

19. The electronic system as claimed in claim 11, wherein said display module is disposed externally of said electronic apparatus.

20. The electronic system as claimed in claim 11, wherein said electronic apparatus is a computer apparatus.

21. The electronic system as claimed in claim 11, wherein the application program is a multi-media application.

22. An electronic system comprising:
an electronic apparatus having an output port, capable of executing an application program, and capable of generating state information and providing the state information to said output port when executing the application program; and
a display module including
a display panel,
an input port coupled to said output port of said electronic apparatus so as to receive the state information therefrom, and
a controller unit coupled to said input port and said display panel, and operable so as to control said display panel to generate a visual indication corresponding to the state information received by said input port.

23. The electronic system as claimed in claim 22, wherein said display panel is one of a vacuum fluorescent display and a liquid crystal display.

24. The electronic system as claimed in claim 22, wherein said controller unit includes a digital signal processor coupled to said input port, and a display controller coupled to said digital signal processor and said display panel.

25. The electronic system as claimed in claim 22, wherein said electronic apparatus includes a computer-readable storage medium, said program module being resident in said computer-readable storage medium.

26. The electronic system as claimed in claim 22, wherein said display module is disposed externally of said electronic apparatus.

27. The electronic system as claimed in claim 22, wherein said electronic apparatus is a computer apparatus.

28. The electronic system as claimed in claim 22, wherein the application program is a multi-media application.
